(19) United States
(12) Patent Application Publication
(10) Pub. No.: US 2005/0003336 A1
(43) Pub. Date: Jan. 6, 2005

(54) Method and system for learning keyword based materials

(76) Inventor: Dennis R. Berman, Irving, TX (US)

Correspondence Address: HOYT A. FLEMING III, P.O. BOX 140678, BOISE, ID, 83714, US

(21) Appl. No.: 10/613,564

(22) Filed: Jul. 2, 2003

(51) Int. Cl. G09B 3/00

(52) U.S. Cl. 434/322; 434/236

(57) ABSTRACT

A method and system is disclosed for training a learner to learn and memorize at least one unfamiliar learning entity, wherein the learning entity has one or more learning elements. After presenting one or more unfamiliar learning entities to the learner in a contextual presentation, the learner is requested to memorize the unfamiliar learning entities for one or more times in view of the contextual presentation. When checking whether the learner has memorized the learning entities, the contextual presentation is presented to the learner with one or more selected learning entities missing therefrom. The missing learning entities are expected to be filled in by the learner to complete the contextual presentation so as to prove that the learner has memorized the learning entities. When each learning element of the learning entity is being provided by the learner, it is monitored and evaluated in real time before the learner completes each learning entity.

### BACKGROUND

This invention relates to a system and method for a memory building process and, more particularly, to a method and system for helping a user to learn and memorize unfamiliar materials.

Learning is a continuing process in life that requires continuous memorization of new concepts, ideas, terms, names, etc. Although a variety of methods have been developed for building a fast and effective memorization process, it is a constant search for finding a better, faster way for enhancing people's memorization process for their daily uses.

Learning by reading has been the conventional learning method for centuries. A provided learning material may contain sufficient explanatory contents to help a learner to understand and memorize the subject matter. However, purely reading the learning material is not the best way to quickly memorize the new concepts contained because a huge portion of the learning material is used not for helping the learner to memorize the concepts, but for helping the learner to understand the concepts. Therefore, the learner may be distracted in her learning process to grasp the gist of the learning material. It is thus not uncommon that although, in a learning process, the concept may have to be explained in details paragraph after paragraph, the gist of the concept may only hinge on a few keywords. Consequently, to learn or to memorize the new concept depends on how well a learner can memorize the keywords. Therefore, a learning platform designed to help the learner to quickly grasp and master the new concepts extracted from the learning material will speed up the learning process.

Further, in the context of training, after the learners are expected to have memorized concepts conveyed in the learning material, it is very difficult to benchmark how much of the learning material the learners have actually mastered. For example, a multiple choice test may be designed and given to the learners to check how well the learners have learned. However, it is well known that it is a common practice for the learner to guess the answer when she encounters a subject that she knows very little about during a multiple choice exam. She might lack the knowledge to answer the question, but she may be lucky to get the answer right. Further, she may also get some of the answers right just because the answer is clearly shown in the provided choices and she is hinted. As such, the value of the multiple choice exams is only good to a certain extent. When it is required that the learners must know all the material being taught, or a testing authority must be assured that certain concepts in the learning material must be mastered by the learner, the multiple choice test is obviously not the best choice.

What is needed, therefore, is a method and system for learning and memorizing unfamiliar materials.

### SUMMARY

A method and system is disclosed for training a learner to learn and memorize at least one unfamiliar learning entity, wherein the learning entity has one or more learning elements. After presenting one or more unfamiliar learning entities to the learner in a contextual presentation, the learner is requested to memorize the unfamiliar learning entities for one or more times in view of the contextual presentation. When checking whether the learner has memorized the learning entities, the contextual presentation is presented to the learner with one or more selected learning entities missing therefrom. The missing learning entities are expected to be filled in by the learner to complete the contextual presentation so as to prove that the learner has memorized the learning entities. When each learning element of the learning entity is being provided by the learner, it is monitored and evaluated in real time before the learner completes each learning entity. A visual feedback may be provided to the learner indicating incorrectness of the provided learning element.

The present disclosure presents an improved method and system to assure that the learners have mastered the unfamiliar materials. Further, the method and system provides an improved method for learning the materials initially by focusing on the identified learning entities, thereby helping the learner to master the key concepts in the most effective way possible.

### BRIEF DESCRIPTION OF THE DRAWINGS

FIG. 1 is a block diagram illustrating the components of a learning system according to one example of the present disclosure.

FIG. 2 is an exemplary representation of a learning display presented to the learner to enable the learner to learn the contextual presentation provided therein according to one example of the present disclosure.

FIG. 3 is an exemplary representation of a learning display presented to the learner to enable the learner to type in characters of a keyword according to one example of the present disclosure.

FIG. 4 is a flowchart showing steps implemented to check the learner's typed mistakes and to provide an alert mechanism to the learner, during a knowledge intake stage, according to one example of the present disclosure.

FIG. 5 is a flowchart showing steps implemented to check the learner's typed mistakes, and to provide alert and hint mechanisms to the learner during a reinforcement stage, according to one example of the present invention.

### DETAILED DESCRIPTION

The present disclosure describes a method and system for learning and memorizing unfamiliar materials. As an example, it is explained in the context of word groups as learning entities. It is understood that similar concept is widely applicable for learning and memorizing any learning entities such as keywords of any other kinds, symbols, or even graphics, and is applicable for any other languages as well. The term “keywords” is understood to include any computer keyboard initiated display elements such as characters, symbols, etc. Moreover, for explanation purposes, one or more specific examples are used with regard to memorizing text based learning entities which includes learning elements. For this disclosure, the term character is defined broadly to include alphabets, numerals, as well as symbols.

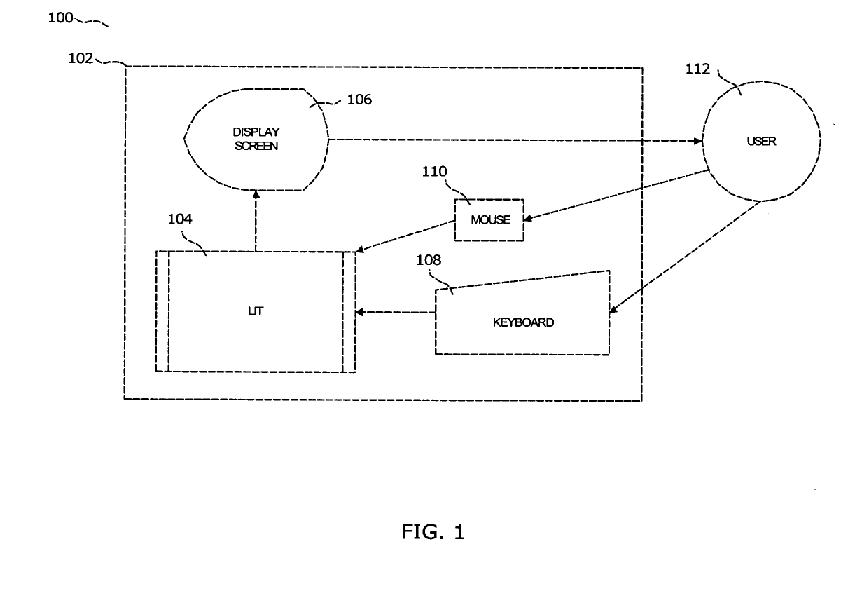

With reference to FIG. 1, a block diagram shows the functional components of a personal computer 102 on which is executed a learning tool 104. Personal computer 102 is generally conventional in design, and details concerning its operations are well known to those of ordinary skill in the art. In addition to the learning tool 104, personal computer 102 includes a display screen 106, a keyboard 108 and a mouse 110. Learning tool 104 is visualized through a display screen 106 and projected to a learner 112, who interacts therewith by controlling keyboard 108, as well as mouse 110 or any other interactive communication device that allows the learner 112 to control a cursor on display screen 106 and for selecting text and control options.

In a preferred embodiment, personal computer 102 employs a graphical user interface, such as Windows 98, a product of Microsoft Corporation. Learner 114 loads learning tool 104 to personal computer 102 through another visual program, such as Internet Explorer 5, another product of Microsoft Corporation. However, it will be understood that learning tool 104 can be implemented in other visual programs running in other graphical user interfaces.

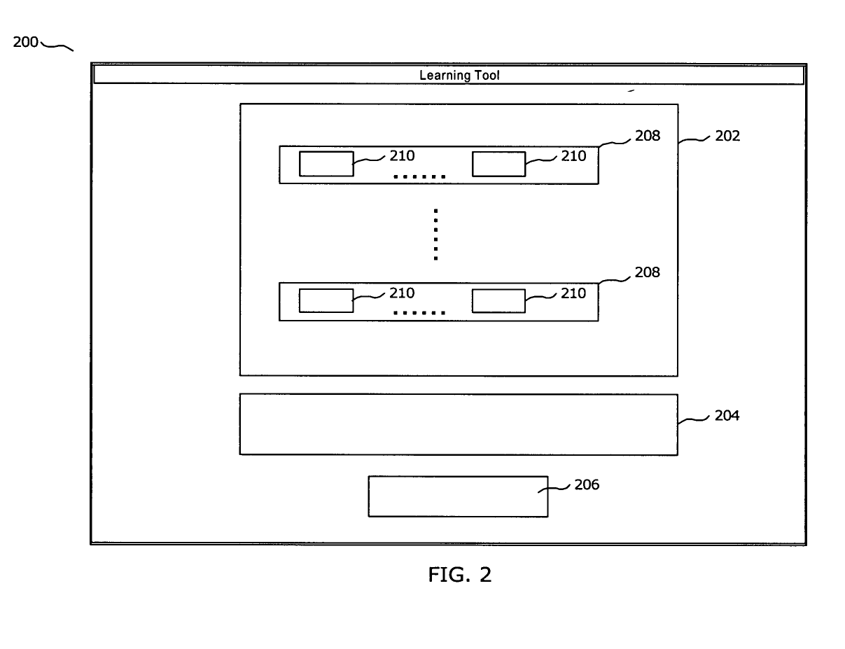

A learning display 200 of the learning tool appears generally as shown in FIG. 2. Learning display 200 includes contextual presentation 202, instruction information 204 and interactive button 206. Instruction information 204 presents instructional information relevant to learner 112's learning stages. Interactive button 206 presents an opportunity for learner 112 to proceed during a learning stage. However, it will be understood that the relative positions of contextual presentation 202, instruction information 204 and interactive button 206 can be implemented differently.

Contextual presentation 202 includes various learning entities 208, each of which includes various learning elements 210. In the preferred embodiment, contextual presentation 202 presents a set of learning material. The set of learning material includes a set of keywords, which are represented by the various learning entities 208. Each keyword is therefore an entity, which includes various learning elements 210 representing a set of characters. Each character is therefore in this example a learning element. Instruction information 204 instructs learner 112 to learn the contextual presentation by reading the learning materials provided therein. Instruction information 204 also instructs learner 112 to focus on certain highlighted keywords. At this point learner 112 attempts to learn the contextual presentation by memorizing the keywords appearing therein. By focusing on the keywords, learner 112 may be able to quickly grasp the gist of the learning material. After the learner completes the instruction as instructed by instruction information 204, the learner continues by pressing interactive button 206.

As an example, when a learner is expected to remember that the state of Texas has three most populated cities, a contextual presentation may be designed to present two groups of learning entities. In the preferred embodiment, these two groups of learning entities are two word groups, the first of which may define a question: “Which ones are the three largest cities in Texas?” while the second of which may define an answer: “Dallas, Houston, and San Antonio.” At this point, the answer is highlighted in blue color, thereby suggesting that the gist of the material involves the names and spellings of the three cities. Also at this point, the instruction information may read: “Please read the question and the answer thoroughly, focusing on the keywords highlighted in blue”, while the interactive button may read: “continue”.

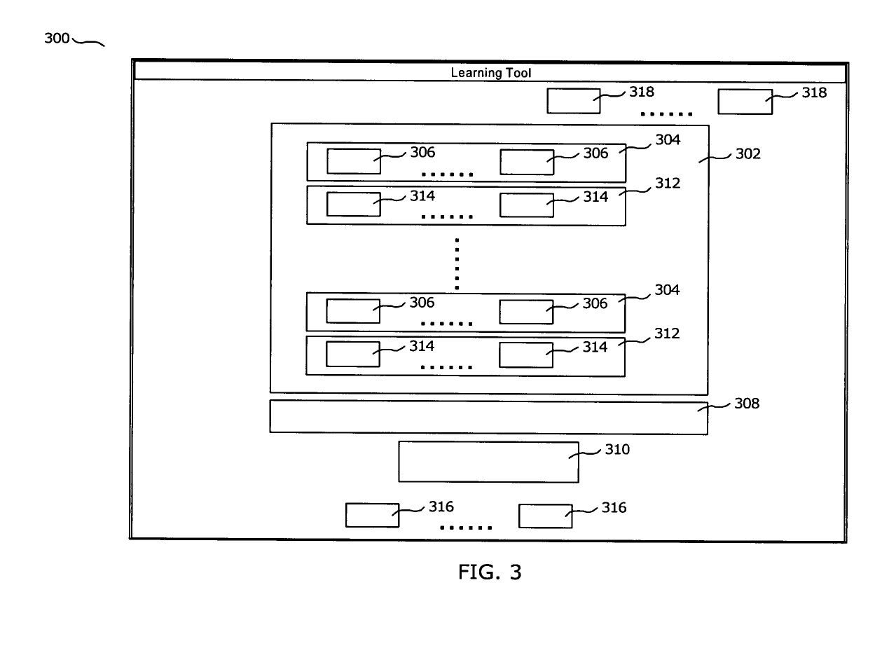

After interactive button 206 is pressed, the learning tool presents the learner 112 with learning display 300 in FIG. 3. Learning display 300 is a variation of learning display 200, with contextual presentation 302 in FIG. 3 corresponding to contextual presentation 202 in FIG. 2, learning entities 304 in FIG. 3 corresponding to learning entities 208 in FIG. 2, learning elements 306 in FIG. 3 corresponding to learning entities 210 in FIG. 2, instruction information 308 in FIG. 3 corresponding to instruction information 204 in FIG. 2, as well as interactive button 310 in FIG. 3 corresponding to interactive button 206 in FIG. 2. The difference is the addition of blank entities 312 and blank elements 314 in FIG. 3. Blank elements are visual positions wherein the learner may, through the keyboard, type a character. At this point, each learning entity 304 has a corresponding blank entity 312. Instruction information 308 then instructs the learner to type verbatim all the learning elements 306 in each learning entity 304 to the corresponding blank elements 314 for each blank entity 312. Also at this point, interactive button 310 is not visible until such time that all learning entities 304 are correctly typed verbatim into their corresponding blank entities 312.

To continue the previous example of Texas cities, the learner presses the “continue” button, after which the learning tool presents another learning display. This learning display presents the two previously displayed word groups, namely, the question and the answer. Below each word group, the learning tool provides a corresponding blank line, which comprises of blank spaces, wherein the learner is expected to type verbatim all the alphabetic characters of some or all the words contained in the word group. The instruction information may read: “Please type the question in the blanks exactly as it appears. Then type the answer keywords in the spaces below.” Until such time that all alphabetic characters are correctly typed verbatim into their corresponding blank spaces, the interactive button is not visible. When an incorrect alphabetic character is typed, the incorrect alphabetic character may be highlighted in red, while the instruction information may read: “Check the spelling, letter, or number”, thereby prompting the learner that a mistake has been made. In one scenario, the learner may attempt to type “Austin” under “Dallas”, which is part of the correct answer. Once the alphabetic character “A” is typed, the learning tool may highlight the alphabetic character “A” in red, while the instruction information may read: “Check the spelling, letter, or number”. In another scenario, the learner may attempt to type “El Paso” under “Dallas”. Once the alphabetic character “E” is typed, the learning tool may highlight the alphabetic character “E” in red, while the instruction information may read: “Check the spelling, letter, or number”. The learner will only be able to continue if “Dallas” is typed. After all the words are correctly typed verbatim, the instruction information may read: “You have correctly retyped both the question and the answer. Please click ‘continue’ to proceed”, while the interactive button may read: “continue”.

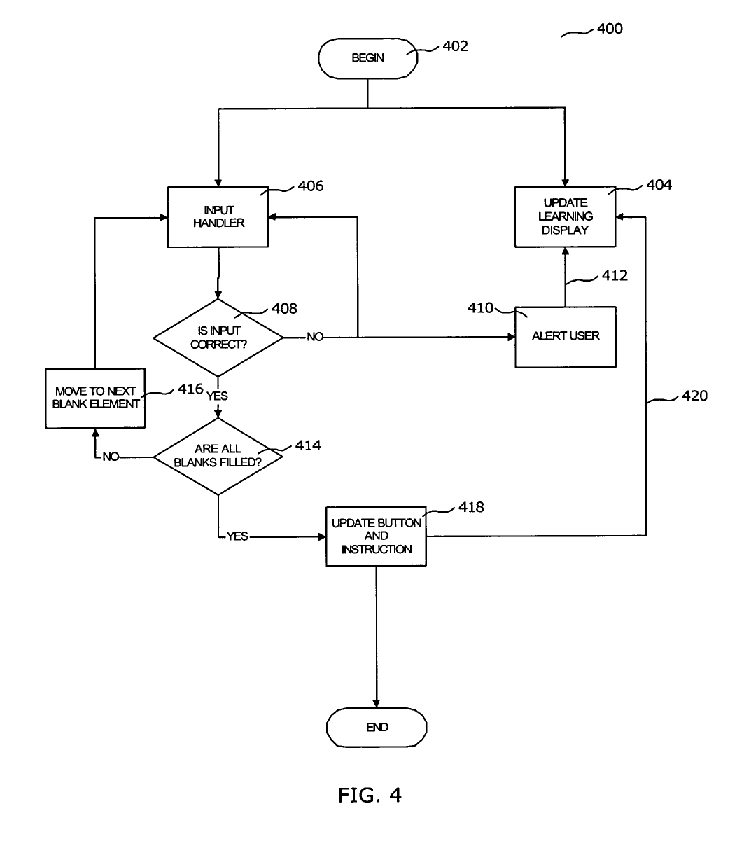

The logical steps in this knowledge intake stage, which embodies knowledge intake, are illustrated in a flowchart 400 in FIG. 4. Starting at begin block 402, the logic proceeds to two process blocks, blocks 404 and 406. Block 404 provides for a visual update as the learner types into the learning tool. Block 406 provides for an input handler, which compares the typed alphabetic character against the corresponding learning element. The result of this process is passed to a decision block 408. If the response to decision block 408 is negative, the logic proceeds to a block 410, which alerts the learner that a mistake has been made. Line 412 represents the instruction by block 410 to block 404 to highlight the mistake in the learning display. If the response to decision block 408 is negative, the logic also proceeds to block 406 in order to instruct the learning tool to continue comparing the learner's typed characters against the corresponding learning elements. Until a correct response to block 408 is given, that is, until a character is typed correctly, the learner is prohibited from typing to the next blank element.

If the response to decision block 408 is positive, the logic proceeds to a decision block 414, which determines whether all blank elements are filled. If not, the logic proceeds to a process block 416, which moves the focus to the next element, where another character typed by the learner is again compared against the corresponding learning element in block 406. If the response to block 414 is positive, all blank elements are filled and the logic proceeds to a process block 418, which updates the instruction information to indicate to the learner to proceed to the next learning stage. Block 418 also labels the interactive button “continue”. Line 420 represents the instruction by block 418 to block 404 to make the interactive button visible in the learning display. At this point, the described knowledge intake stage is completed.

The logical steps in this knowledge intake stage, according to the previous example of Texas cities, are described as follows. In one scenario, the alphabetic character “E” in the incorrect answer of “El Paso” is typed into the blank line. This alphabetic character “F” is then compared against the alphabetic character “D” in the correct answer of “Dallas”. Since the response is negative, the logic proceeds to alert the learner by highlighting the mistake, which is the alphabetic character “E”. Once the correct alphabetic character “D” is typed, the logic proceeds by moving focus to the next alphabetic character, or the “a” immediately after “D” in “Dallas”. This logic repeats itself until all the alphabetic characters are typed correctly to the blank line. At this point, the instruction information may read: “You have correctly retyped both the question and the answer. Please click ‘continue’ to proceed”, while the interactive button becomes visible and may read: “continue”. At this point, the described knowledge intake stage is completed.

After the knowledge intake stage previously described is completed, the learning tool proceeds by reinforcing the knowledge by requiring the learner to fill out certain various blank elements in various blank entities in the learning display. At this reinforcement stage, the learning display is similar to learning display 300, except that where the learning entities are visible, the corresponding blank entities are invisible, and where the blank entities are visible, the corresponding learning entities are invisible. In other words, certain learning entities, such as a question, are visible while the corresponding blank entities, such as various keywords in an answer, are no longer visible. At this point, since the learning entities that represent the answer are no longer visible, the learner can no longer copy verbatim therefrom but has to rely on the learner's capacity to associate the question, or the visible learning entities, to one or more learned keywords, or one of more blank entities. At this reinforcement stage, the learning tool also has a hint function that reveals the various learning elements in various blank entities, thereby helping the learner to remember, without entirely giving away the answer, the full set of characters, or learning elements, and keywords, or learning entities, in the contextual presentation. In another example, the learner can identify specific keywords that she wants to be hinted on by using a user interface device such as a mouse. The hints will only be given to the identified keywords, and not others. The learner can also type in selected portions of the answer line and leave the others to be hinted on.

To continue the previous example of Texas cities, after the knowledge intake stage is completed, the learning tool proceeds by reinforcing the knowledge by requiring the learner to type an answer under a question. At this reinforcement stage, the question: “Which ones are the three largest cities in Texas?” may still be visible, but the answer thereto is not. The learner must then rely on learned knowledge in order to successfully type the answer to an answer line provided below the question. If the learner uses the hint function, the hint mechanism may reveal some of the alphabetic characters of the answer. In the preferred embodiment, the hint mechanism may reveal the first character of each word of the answer: “Dallas, Houston, and San Antonio”. In other words, the answer line with a first round of hint may look like this: “D_, H_, and S_A_”. The learner may also use the hint function more than once. As an example, the hint mechanism may reveal more characters of the answer in order to provide more hints to the learner. For example, selected characters of the keywords can be placed leaving a few blanks. For instance, the answer line with a second round of hint may look like this: “D_ll_s, H_st_n, and S_n Ant_n_”.

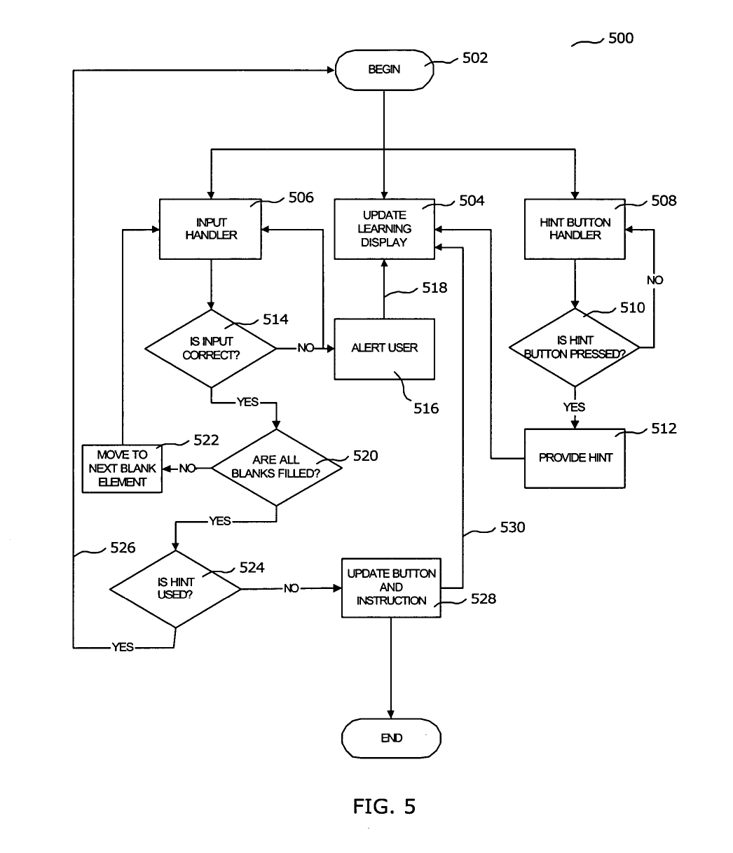

The logical steps in this reinforcement stage, which embodies knowledge reinforcement, are illustrated in a flowchart 500 in FIG. 5. Starting at begin block 502, the logic proceeds to three process blocks, blocks 504, 506 and 508. Block 504 provides for a visual update as the learner types into the learning tool. Block 506 provides for an input handler, which compares the typed alphabetic character against the corresponding learning element not dissimilar to block 406. Block 508 provides for a hint button handler, which handles the hint function if the learner presses the hint button to ask for a hint. The result of this process is passed to a decision block 510. If the response to decision block 510 is negative, the logic proceeds back to 508. If the response to decision block 510 is positive, the logic proceeds to a block 512, which in turn instructs block 504 to provide hints to the learning display. In the immediate example above, the first learning element of each learning entity is displayed to the learner; that is, the first character of each keyword is displayed to the learner. If the learner needs further hints, various learning elements, such as all consonants of a word, of each learning entity or each keyword is displayed to the learner. If the learner needs further hints, all the learning elements, including the vowels of a keyword, of each learning entity is displayed to the learner. This step-by-step hint process provides room for the learner to recall the learned entities in the context of the provided hints.

Block 506 handles all characters typed by the learner. The result from block 506 is then passed to a decision block 514. If the response to decision block 514 is negative, the logic proceeds to a block 516, which alerts the learner that a mistake has been made. Line 518 represents the instruction by block 516 to block 504 to highlight the mistake in the learning display. If the response to decision block 514 is negative, the logic also proceeds to block 506 in order to instruct the learning tool to continue comparing learner's typed characters against the corresponding learning elements. Until a correct response to block 514 is given, that is, until a character is typed correctly, the learner is prohibited from typing to the next blank element.

If the response to decision block 514 is positive, the logic proceeds to a decision block 520, which determines whether all blank elements are filled. If not, the logic proceeds to a process block 522, which moves the focus to the next element, where another character typed by the learner is again compared against the corresponding learning element in block 506. If the response to block 520 is positive, all blank elements are filled and the logic proceeds to a decision block 524. If the response to block 524 is positive, the learner has completed all entities correctly but will have to restart this reinforcement stage again until the learner fills out all blank elements correctly without using the hint button. Line 526 represents the instruction by decision block 524 to restart the reinforcement stage, which starts at begin block 502. If the response to block 524 is negative, the learner has completed all entities correctly without using the hint button. The logic proceeds to a process block 528, which updates the instruction information to indicate to the learner to proceed to the next learning stage. Block 528 also labels the interactive button “continue”. Line 530 represents the instruction by block 528 to block 504 to make the interactive button visible in the learning display. At this point the reinforcement stage is completed.

The logical steps in this reinforcement stage, according to the previous example of Texas cities, are described as follows. In one scenario, the alphabetic character “E” in the incorrect answer of “El Paso” is typed into the blank line. This alphabetic character “E” is then compared against the alphabetic character “D” in the correct answer of “Dallas”. Since the response is negative, the logic proceeds to alert the learner by highlighting the mistake, which is the alphabetic character “E”. Once the correct alphabetic character “D” is typed, the logic proceeds by moving focus to the next alphabetic character, or the “a” immediately after “D” in “Dallas”. This logic repeats itself until all the alphabetic characters are typed correctly to the answer line. If the learner presses the hint button, the logic may require the learner to answer the question again until the learner types all the alphabetic characters correctly without the use of the hint button. At this point, the instruction information may read: “You have answered the question without a hint. Click ‘next question’ to continue”, while the interactive button becomes visible and may read: “continue”. At this point, the knowledge reinforcement stage is completed.

During the knowledge reinforcement stage previously described, as the learner progresses from one question to another, learning display 300 may include various status elements 316 such as graphic feedback items, each of which tracks the progress of the learner in one particular question. For example, a color ball may represent how the learner has handled a particular question. If the learner has correctly answered the question in the first instance, then the ball may be painted green. If the learner has used the hint once to get the answer right, the ball may show an orange color. If the learner has to use multiple times of the hint feature, the ball may be shown as red to indicate that the learner has not master the keyword based material covered by this particular question. The learning display may also include various indicator elements 318 which, as a group, indicate how many times the question is answered correctly without a hint. It is noted that the learning tool can also check the learner's knowledge after the knowledge enhancement stage by posing questions as they were in the contextual presentations. Evaluations can be done then in a similar manner.

After all the questions are posed, a score report is presented to the learner indicating how the learner has performed in each of the questions. In one example, if a question is answered correctly without a hint, it is marked with a green star. If a question is answered correctly only with at least one hint, it is marked with a red cross. The learner can click directly on the star or cross to get back to the particular question page. Further, if the learner has answered some questions correctly without any hint in a first round, the next round of presentation may only include the questions that she has failed to answer correctly without a hint. In essence, by repetition, the learner can quickly master the unfamiliar learning material.

As an example, the learning tool requires the learner to answer five questions, each of which must be answered twice correctly without a hint. For each question, there is a corresponding status element. In this example, each status element appears either: in blue, which states that the learner has not answered the corresponding question correctly without a hint; in orange, which states that the learner has answered the corresponding question correctly in one round without a hint; or in green, which states that the learner has answered the corresponding question correctly in two rounds without a hint. For every question displayed in the learning display, there are two indicator elements 318, each of which initially appears in white. For each time that the answer is answered correctly without a hint, one indicator element appears in green. Both indicator elements for one question will therefore appear green only if the question is answered twice correctly without a hint.

It is understood that the flow charts 400 and 500 can be implemented in computer systems with appropriate software design. For example, a central server running the appropriate software programs may be accessed by multiple users through various access means including through web browsers. In another example, appropriate software programs may be loaded in a learner specific computer system and can only be accessed by such a learner.

It is further understood that reports about the learner's activities with regard to the learning tool can be tracked closely and automatically. For example, as described above, information about whether the learner has taken a hint or how many times she has taken the hint can be recorded. More so, whether a learner can be deemed as one who has mastered the learning material may depend on several predetermined thresholds. And one of such thresholds may be how many times the learner has taken the hint. In another example, the learning tool may be programmed to require the learner to type the learning entities correctly without any hint throughout the reinforcement stage. Or, if the learner has asked for a hint once, then he has to type the learning entities without mistakes for multiple times. In essence, it is up to the operator of the learning tool to set such criteria so that the operator is assured that the learner has learned the knowledge and such newly learning knowledge is further enhanced. This also eliminates the uncertainty caused by multiple choice tests.

The above disclosure provides many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

1. A method for training a learner to learn and memorize one or more unfamiliar learning entities, the learning entity having one or more learning elements, the method comprising:
presenting one or more unfamiliar learning entities to the learner in a contextual presentation;
requesting the learner to memorize the unfamiliar learning entities for one or more times in view of the contextual presentation;
presenting the contextual presentation to the learner with one or more selected learning entities missing therefrom, the missing learning entities being expected to be filled in by the learner to complete the contextual presentation so as to prove that the learner has memorized the learning entities;
monitoring each learning element of the learning entity provided by the learner;
evaluating each learning element in response to the learning element provided by the learner before the learner completes each learning entity; and
providing a visual feedback in real time to the learner indicating incorrectness of the provided learning element.

2. The method of claim 1 further comprising, if a first learning element is evaluated to be incorrect, prohibiting the learner from providing a second learning element subsequent to the first learning element.

3. The method of claim 1 further comprising hinting the learner by providing a starting learning element of one or more selected learning entities in the contextual presentation if the learner can not recall the learning entities and chooses to ask for a hint.

4. The method of claim 3 further comprising hinting the learner by providing one or more additional learning elements of the one or more selected learning entities.

5. The method of claim 1 further comprising allowing the learner to identify one or more learning entities for receiving a hint thereof if the learner can not recall the identified learning entities.

6. The method of claim 1 further comprising hinting the learner by providing one or more learning elements of the one or more identified learning entities.

7. The method of claim 1 wherein the learning entity is a word and the learning element is a character.

8. The method of claim 1 wherein the learning entity is a alphanumerical group and the learning element is an alphabet, a numeral, or a symbol.

9. The method of claim 1 wherein the providing a visual feedback includes highlighting the provided learning element that is evaluated to be incorrect.

10. The method of claim 1 wherein the contextual presentation is in a question and answer form in which the learning entities are in the answer.

11. A method for training a learner to learn and memorize one or more keywords pertaining to unfamiliar subjects, the method comprising:
presenting one or more keywords to the learner in a contextual presentation;
requesting the learner to memorize the keywords for one or more times in view of the contextual presentation;
presenting the contextual presentation to the learner with one or more selected keywords missing therefrom, the missing keywords being expected to be filled in by the learner to complete the contextual presentation so as to prove that the learner has learned and memorized the keywords;
monitoring each character of the keyword provided by the learner;
evaluating each character in real time as the character is being provided; and
providing a visual feedback to the learner indicating incorrectness of the provided character.

12. The method of claim 11 further comprising, if a first character is evaluated to be incorrect, prohibiting the learner from providing a second character subsequent to the first character.

13. The method of claim 11 further comprising hinting the learner by providing a starting character of one or more selected keywords in the contextual presentation if the learner can not recall the keywords and chooses to ask for a hint.

14. The method of claim 13 further comprising hinting the learner by providing one or more additional characters of the one or more selected keywords.

15. The method of claim 13 further comprising allowing the learner to identify one or more keywords for receiving a hint thereof if the learner can not recall the identified keywords.

16. The method of claim 15 further comprising hinting the learner by providing one or more characters of one or more identified keywords.

17. The method of claim 11 wherein the providing a visual feedback includes highlighting the provided character that is evaluated to be incorrect.

18. A computer program for training a learner to learn and memorize at least one unfamiliar learning entity, the learning entity having one or more learning elements, the program comprising instructions:
presenting one or more unfamiliar learning entities to the learner in a contextual presentation;
requesting the learner to memorize the unfamiliar learning entities for one or more times in view of the contextual presentation;
presenting the contextual presentation to the learner with one or more selected learning entities missing therefrom, the missing learning entities being expected to be filled in by the learner to complete the contextual presentation so as to prove that the learner has memorized the learning entities;
monitoring each learning element of the learning entity provided by the learner;
evaluating each learning element in response to the learning element provided by the learner before the learner completes each learning entity; and
providing a visual feedback in real time to the learner indicating incorrectness of the provided learning element.

19. The program of claim 18 further comprising instructions for prohibiting the learner from providing a second learning element subsequent to the first learning element if a first learning element is evaluated to be incorrect.

20. The program of claim 18 further comprising instructions for hinting the learner by providing a starting learning element of one or more selected learning entities in the contextual presentation if the learner can not recall the learning entities and chooses to ask for a hint.

21. The program of claim 20 further comprising instructions for hinting the learner by providing one or more additional learning elements of the one or more selected learning entities.

22. The program of claim 18 further comprising instructions for allowing the learner to identify one or more learning entities for receiving a hint thereof if the learner can not recall the identified learning entities.

23. The program of claim 18 wherein the instructions for providing a visual feedback includes instructions for highlighting the provided learning element that is evaluated to be incorrect.

24. The program of claim 18 wherein the contextual presentation is in a question and answer form in which the learning entities are in the answer.

25. A method for training a learner to learn and memorize one or more unfamiliar learning entities, the learning entity having one or more learning elements, the method comprising:
presenting one or more unfamiliar learning entities to the learner in a contextual presentation of a question-answer form;
requesting the learner to type the unfamiliar learning entities for one or more times in view of the contextual presentation;
presenting the contextual presentation to the learner with one or more selected learning entities missing therefrom, the missing learning entities being expected to be filled in by the learner to complete the contextual presentation so as to prove that the learner has memorized the learning entities;
monitoring each learning element of the learning entity provided by the learner;
evaluating each learning element in response to the learning element provided by the learner before the learner completes each learning entity;
if a first learning element is evaluated to be incorrect, prohibiting the learner from providing a second learning element following the first learning element;
if the learner can not recall the learning entities and chooses to ask for a hint, hinting the learner in a first round by providing a starting learning element of one or more selected learning entities in the contextual presentation; and
hinting the learner in a second round by providing one or more additional learning elements of the one or more selected learning entities.

26. The method of claim 25 wherein the learning entity is a word and the learning element is a character.

27. The method of claim 25 wherein the learning entity is a alphanumerical group and the learning element is an alphabet, a numeral, or a symbol.
